(19) United States
(12) Patent Application Publication
(10) Pub. No.: US 2025/0011541 A1
(43) Pub. Date: Jan. 9, 2025

(54) TUNABLE POLYISOBUTYLENE POLYURETHANE

(71) Applicant: Boston Scientific Scimed, Inc., Maple Grove, MN (US)

(72) Inventors: Yen-Hao Hsu, Shrewsbury, MA (US); Mark W. Boden, Harrisville, RI (US)

(21) Appl. No.: 18/762,450

(22) Filed: Jul. 2, 2024

Related U.S. Application Data
(60) Provisional application No. 63/524,740, filed on Jul. 3, 2023.

(51) Int. Cl. C08G 71/04; C08L 23/22; C08L 23/36

(52) U.S. Cl. CPC C08G 71/04; C08L 23/22; C08L 23/36; C08L 2203/02; C08L 2203/16; C08L 2203/18

(57) ABSTRACT

A polymeric material having a polyisobutylene polyurethane. The polyisobutylene having soft segments including a polyisobutylene diamine residue, and hard segments including bis-cyclic carbonate residue.

### CROSS-REFERENCE TO RELATED APPLICATIONS

The application claims priority to U.S. Provisional Application No. 63/317,732, filed Jul. 3, 2023, which is herein incorporated by reference in its entirety.

### TECHNICAL FIELD

The present disclosure relates to polymeric materials. More specifically, the disclosure relates to polyisobutylene-polyurethane block copolymers, methods for making polyisobutylene-polyurethane block copolymers, and medical devices containing polyisobutylene-polyurethane block copolymers.

### BACKGROUND

Polymeric materials are widely used in the field of medical devices. For example, polymeric materials such as silicone rubber, polyurethane, and fluoropolymers are used as coating and/or insulating materials for medical leads, stents, catheters, and other devices.

Thermoplastic polyurethanes (TPUs) can be used in either short-term or long-term implantable devices, such as catheters, polymer discs, and coatings. Block copolymers are polymeric materials made of alternating sections of polymerized monomers. Polyisobutylene polyurethane is a TPU formed from hard segments (such as diisocyanates) and soft segments (hydroxyl-terminated polymers such as polyether, polycarbonate, poly-ε-caprolactone and polyisobutylene). The mechanical (such as hardness and stretchability) and thermal (such as crystallinity and glassy transition) properties of polyisobutylene polyurethane can be tuned, for example, by varying the weight percentage of the hard and soft segments.

However, one challenge with existing polyisobutylene polyurethane manufacturing processes is the formation of undesired urea linkage groups, which can cause unpredictable variation in the molecular weight and thermal and/or mechanical properties of the polyurethane.

Additionally, non-covalently bound coatings have been used on polyisobutylene polyurethanes to reduce or prevent biofilm accumulation on the polymer surface. However, a covalently bound coating would provide an improved coating and sufficient lubricity while also preventing biofilm accumulation.

### SUMMARY

Example 1 is a polymeric material having a polyisobutylene polyurethane. The polyisobutylene having soft segments including a polyisobutylene diol residue, and hard segments including bis-cyclic carbonate residue.

Example 2 is the polymeric material of Example 1, wherein the polyisobutylene polyurethane is free of urea linkages.

Example 3 is the polymeric material of Example 1, wherein the hard segments further include ethanol side chains.

Example 4 is the polymeric material of Example 1, wherein the hard segments further include modifying moieties covalently bonded to a polymer backbone.

Example 5 is the polymeric material of Example 4, wherein the modifying moieties are from bromine-terminated polyethylene glycol (PEG-Br), quaternary ammonium bromine-terminated derivatives (small molecule or polymer-based), bromine-terminated polyvinylpyrrilidone (PVP-Br) or bromine-terminated poly (2-methyl-2-oxazoline).

Example 6 is the polymeric material of Example 4, wherein the modifying moieties are from 8-bromo-1,1,1,2,2,3,3,4,4,5,5,6,6-tridecafluoro-octane, bromine-terminated polytetrafluoroethylene (PTFE-Br) or bromine-terminated polydimethylsiloxane (PDMS-Br).

Example 7 is a medical device having a polymeric material. The polymeric material has soft segments including a polyisobutylene diamine residue and hard segments including bis-cyclic carbonate residue.

Example 8 is the medical device of Example 7, wherein the hard segments further include modifying moieties covalently bonded to a polymer backbone.

Example 9 is the medical device of Example 8, wherein the modifying moieties are only present at surfaces of the polyisobutylene polyurethane.

Example 10 is the medical device of Example 8, wherein the modifying moieties are present throughout the polyisobutylene polyurethane.

Example 11 is a method of making a polymeric material that includes forming amino-terminated polyisobutylene from hydroxyl-terminated polyisobutylene; and performing ring-opening polymerization with bis-cyclic carbonate and the amino-terminated polyisobutylene to form polyisobutylene polyurethane.

Example 12 is the method of Example 11, wherein forming the amino-terminated polyisobutylene includes adding methanesulfonyl chloride and ammonia to hydroxyl-terminated polyisobutylene.

Example 13 is the method of Example 11, wherein the bis-cyclic carbonate and the amino-terminated polyisobutylene are present in the ring-opening polymerization in equal molar amounts.

Example 14 is the method of Example 11, and further comprising performing a S_{N}² reaction with the polyisobutylene polyurethane to form a modified polyisobutylene polyurethane.

Example 15 is the method of Example 14 wherein the S_{N}² reaction includes bromine-terminated polyethylene glycol (PEG-Br), quaternary ammonium bromine-terminated derivatives (small molecule or polymer-based), bromine-terminated polyvinylpyrrilidone (PVP-Br) or bromine-terminated poly (2-methyl-2-oxazoline).

Example 16 is the method of Example 14, wherein the S_{N}² reaction includes 8-bromo-1,1,1,2,2,3,3,4,4,5,5,6,6-tridecafluoro-octane, bromine-terminated polytetrafluoroethylene (PTFE-Br) or bromine-terminated polydimethylsiloxane (PDMS-Br).

Example 17 is the method of Example 14, and further comprising forming the polyisobutylene polyurethane into a medical device.

Example 18 is the method of Example 17 wherein the S_{N}² reaction is performed before forming the medical device.

Example 19 is the method of Example 17 wherein the S_{N}² reaction is performed after forming the medical device.

Example 20 is the method of Example 19 wherein the S_{N}² reaction includes a polymer or molecule having a leaving group and a modifying moiety, wherein the leaving group is selected from the group consisting of bromide, iodide, chloride, tosylates and mesylates, and wherein the modifying moiety is selected from the group consisting of polyacrylates, acrylic acid copolymers, polyethylene glycol (PEG), polyvinylpyrrolidone (PVP), polyoxazolines, quaternary ammonium-functionalized polymers or molecules, glycosaminoglycans and peptides.

While multiple examples are disclosed, still other examples in accordance with this disclosure will become apparent to those skilled in the art from the following detailed description, which shows and describes illustrative embodiments. Accordingly, the drawings and detailed description are to be regarded as illustrative in nature and not restrictive.

### BRIEF DESCRIPTION OF THE DRAWINGS

FIG. 1 is a schematic diagram illustrating a process to produce polyisobutylene-polyurethane according to some embodiments of this disclosure.

FIG. 2 is a schematic diagram illustrating a second (optional) step of a process to produce polyisobutylene-polyurethane according to some embodiments of this disclosure.

While this disclosure is amenable to various modifications and alternative forms, specific embodiments have been shown by way of example in the drawings and are described in detail below. The intention, however, is not to limit the disclosure to the particular embodiments described. On the contrary, this disclosure is intended to cover all modifications, equivalents, and alternatives falling within the scope of the disclosure as defined by the appended claims.

### DETAILED DESCRIPTION

In accordance with various aspects of the disclosure, polyisobutylene-polyurethane block copolymers (also referred to herein collectively as “PIB-PUR”) and methods for making the same are disclosed. Medical devices that can be implantable or insertable into the body of a patient and that comprise a polyisobutylene urethane copolymer are also disclosed. PIB-PUR is a thermoplastic polyurethane (TPUs) that contains hard and soft segments. The PIB-PUR can be biocompatible and have enhanced biostability compared to current thermoplastic polyurethanes currently used. PIB-PUR is useful in a number of applications, including in medical devices used for insertion or implantation into a patient because they are hydrolytically stable and have good oxidative stability. Exemplary medical devices include guidewires, stents, drainage catheters, pacemaker leads, left atrial appendage closure devices, percutaneous nephrolithotomy (PCNL) procedure, hydrogels, implantable meshes and artificial heart valves.

Previously, polyisobutylene polyurethanes were synthesized from polyfunctional isocyanates (e.g., diisocyanates, including both aliphatic and aromatic diisocyanates) and polyols (e.g., macroglycols). However, isocyanate is water-sensitive and can be converted to a primary amine which can react with free isocyanate to produce undesired urea linkage groups (CO(NH₂)₂. That is, the isocyanate can form urea linkage groups rather than the desired urethane formation. The urea linkage group can result in unpredictable variation in the molecular weight and thermal and mechanical properties and causes difficulty in quality control.

Disclosed herein is a new synthesis process for polyisobutylene polyurethanes which avoids the formation of urea linkage groups, resulting in a naturally hydrophilic coating to provide lubricity on the outer surface of the polymer and an opportunity to covalently bond functional groups, such as polymers or molecules, to the polymer to further tune the properties of the polyisobutylene polyurethane.

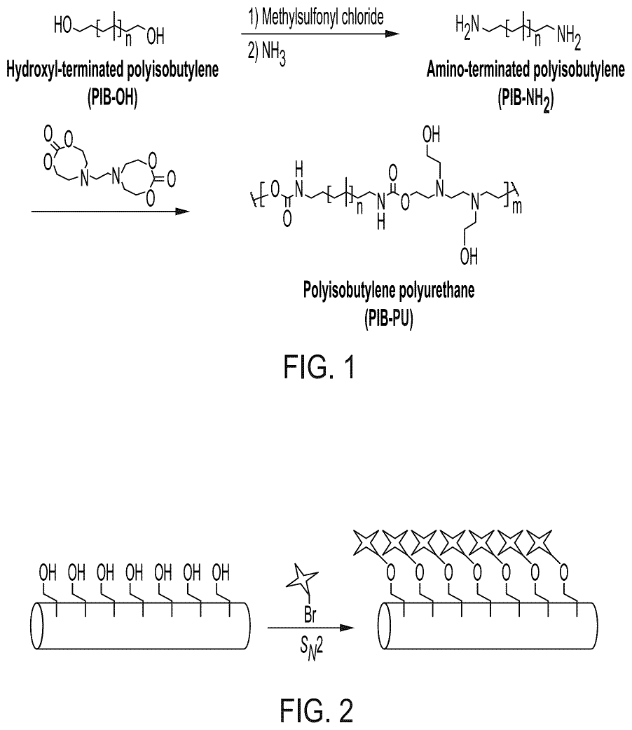

FIG. 1 is a schematic diagram illustrating a process to produce polyisobutylene-polyurethane according to some embodiments of this disclosure. A hydroxyl-terminated polyisobutylene (PIB-OH) is used as a starting material. This starting material is combined with methanesulfonyl chloride and ammonia (NH₃), and the hydroxyl end groups are converted to amino end groups to form an amino-terminated polyisobutylene (PIB-NH₃). In some embodiments, p-toluene sulfonyl chloride can be used in place of methanesulfonyl chloride.

In a second step, the amino-terminated polyisobutylene (PIB-NH₃) is used as a micromolecular initiation to undergo ring-opening polymerization with bis-cyclic carbonate to produce the polyisobutylene polyurethane. In some embodiments, PIB-NH₃ and the bis-cyclic carbonate are combined in equal molar amounts. In some embodiments, the ratio of the functional groups of the PIB-NH₃ and the bis-cyclic carbonate are maintained at a 1:1 ratio or close to a 1:1 ratio, for example 0.995 to 1 or 0.995 to 0.995.

As shown in FIG. 1, resulting polyisobutylene polyurethane has soft segments that include a polyisobutylene diamine residue and hard segments containing bis-cyclic carbonate residue and ethanol side chains. These ethanol side chains can provide a naturally hydrophobic coating on the polyisobutylene surface to provide lubricity. The ethanol side chains can also provide an antifouling or anti-bacterial surface. In some embodiments, the ethanol side chains may provide a tunable surface by surface functionalization.

The resulting polyisobutylene polyurethane is free of urea formation or formation of a urea linkage. In some embodiments, the present synthesis results in more predictable and less variation in the molecular weight and thermal and mechanical properties of the polyisobutylene polyurethane in part because of the absence of the urea side reaction. Additionally, the low oxygen content on the backbone of the polyisobutylene polyurethane avoids or reduces further in vivo oxidative degradation.

The weight ratio of soft segments to hard segments in the polyisobutylene polyurethanes of the various embodiments can be varied to achieve a wide range of physical and mechanical properties, and to achieve an array of desirable functional performance. For example, the weight ratio of soft segments to hard segments in the polymer can be varied from 99:1 to 95:5 to 90:10 to 75:25 to 50:50 to 25:75 to 10:90 to 5:95 to 1:99, more particularly from 95:5 to 90:10 to 80:20 to 70:30 to 65:35 to 60:40 to 50:50, and even more particularly, from about 80:20 to about 50:50. In some embodiments, the soft segment components can be about 40% to about 70% by weight of the copolymer, and the hard segment components can be about 30% to about 60% by weight of the copolymer.

In some embodiments, the polyisobutylene polyurethane copolymer may include polyisobutylene in an amount of about 60% to about 100% by weight of the soft segments and a polyether, a polyester, or a polycarbonate in an amount of about 0% to about 40% by weight of the soft segments. For example, the copolymer may include soft segments in an amount of about 40% to about 70% by weight of the copolymer, of which polyisobutylene is present in an amount of about 60% to about 100% by weight of the soft segments and polyether is present in an amount of about 0% to about 40% by weight of the soft segments. In another embodiment, the copolymer may include soft segments in an amount of about 40% to about 70% by weight of the copolymer, of which polyisobutylene (e.g., a polyisobutylene diamine residue) is present in an amount of about 70% to about 95% by weight of the soft segments and a polyether (e.g., polytetramethylene oxide diol residue) is present in an amount of about 5% to about 40% by weight of the soft segments.

As used herein, a “polymeric segment” or “segment” is a portion of a polymer. As used herein, soft and hard segments are relative terms to describe the properties of polymer materials containing such segments. Without limiting the foregoing, a soft segment may display a glass transition temperature (Tg) that is below body temperature, more typically from 35° C. to 20° C. to 0° C. to −25° C. to −50° C. or below. A hard segment may display a Tg that is above body temperature, more typically from 40° C. to 50° C. to 75° C. to 100° C. or above. Tg can be measured by differential scanning calorimetry (DSC), dynamic mechanical analysis (DMA) and/or thermomechanical analysis (TMA).

In some embodiments, the surface of the polyisobutylene polyurethane can be further tuned. More specifically, the ethanol side chains provide an opportunity to tune the surface hydrophilicity or hydrophobicity which can affect the lubricity of the polyisobutylene polyurethane surface and/or prevent or reduce bacteria adhesion. FIG. 2 is a schematic diagram illustrating a second (optional) step of a process to produce polyisobutylene polyurethane in which the surface of the polyisobutylene polyurethane is tuned.

As shown in FIG. 2, the polyisobutylene polyurethane of FIG. 1, which includes ethanol side chains, can be combined with a polymer or molecule containing a modifying moiety. Through a S_{N}2 reaction (a nucleophilic substitution that proceeds via a bi-molecular mechanism), the modifying moiety is covalently bonded to the polymer backbone of the polyisobutylene polyurethane to form a modified polyisobutylene polyurethane. As shown in FIG. 2, the polyisobutylene polyurethane may be combined with a polymer or molecule containing bromide ion(s) (Br) and the desired modifying moiety. Bromide is a good leaving group for the S_{N}2 reaction. Other suitable leaving groups include iodide (I), chloride (CI), tosylates (OTs) and mesylates (OMs).

In some embodiments, the modified polyisobutylene polyurethane has improved hydrophilic properties. Suitable modifying moieties to improve hydrophilic properties include but are not limited to polyacrylates, acrylic acid copolymers, polyethylene glycol (PEG), polyvinylpyrrolidone (PVP), polyoxazolines, quaternary ammonium-functionalized polymers or molecules, glycosaminoglycans (including natural, such as hyaluronic acid (HA) or heparin, or synthetic, such as sulfonated polymers). Suitable polymers or molecules containing a modifying moiety to improve hydrophilic properties include but are not limited to bromine-terminated polyethylene glycol (PEG-Br), quaternary ammonium bromine-terminated derivatives (small molecule or polymer-based), bromine-terminated polyvinylpyrrilidone (PVP-Br) and bromine-terminated poly (2-methyl-2-oxazoline).

Suitable modifying moieties to improve the hydrophobic property of the modified polyisobutylene polyurethane include but are not limited to polydimethylsiloxane (PDMS), polytetrafluoroethylene (PTFE), 2-perfluorohexyl ethyl thiol and polyisobutylene (PIB). Suitable polymers or molecules containing a modifying moiety to improve the hydrophobic property of the modified polyisobutylene polyurethane include but are not limited to 8-bromo-1,1,1,2,2,3,3,4,4,5,5,6,6-tridecafluoro-octane, bromine-terminated polytetrafluoroethylene (PTFE-Br) and bromine-terminated polydimethylsiloxane (PDMS-Br).

In some embodiments, the ethanol sidechains are reacted with active compounds to create pro-drugs. The release rate of the active compound can be controlled by the hydrolysis reaction. In some embodiments, the drug release can be extended for significant periods and provide long term benefits. In some embodiments, the active compound or drug contains carboxylic acid, such as ibuprofen. The carboxylic acid group from the active compound binds onto the polyisobutylene polyurethane by an ester bond. The ester bond gradually degrades in vivo to release the active compound, such as ibuprofen.

Modification of the polyisobutylene polyurethane (e.g., FIG. 2) can be performed before or after forming the final medical device from the polyisobutylene polyurethane. When the polyisobutylene polyurethane is modified before the medical device is formed (i.e., the bulk polyisobutylene polyurethane is modified according to FIG. 2), the bound moiety will be dispersed through the bulk polymer. This may be suitable when tailoring the mechanical properties such as water absorption or modifying drug release kinetics. In one embodiment, a solution suspension is used by combining an organic solvent with specific moieties such as polyvinylpyrrolidone-bromine (PVP-Br) or polyethylene glycol-bromine (PEG-Br) and the polyisobutylene polyurethane. A precipitation procedure can then be conducted.

When the polyisobutylene polyurethane is modified after the medical device is formed, only the properties at the surface of the polyisobutylene polyurethane will be modified. This may be suitable when tailoring the surface properties, such as the hydrophobic or hydrophilic properties of the polyisobutylene polyurethane. When a medical device of polyisobutylene polyurethane is modified according to FIG. 2, the modifying moieties are covalently bonded to the surface of the polyisobutylene polyurethane to form a coating. The covalently bonded coating will not fall apart or delaminate after implantation. A covalent bond is a chemical bond in which electrons are shared between atoms. In contrast, a non-covalent bond is a weaker bond as compared to a covalent bond in part because no chemical reaction takes place (i.e., there is no formation or breaking of a chemical bond).

The polyisobutylene polyurethane according to embodiments of this disclosure can be incorporated into medical devices which can be implanted or inserted into the body of a patient. Example medical devices may include, without limitation, vascular grafts, electrical leads, catheters, leadless cardiac pacemakers (LCP), pelvic floor repair support devices, shock coil coverings, covered stents, urethral stents, internal feeding tubes/balloons, structural heart applications including valve leaflets, suture sleeves, breast implants, ophthalmic applications including intraocular lenses and glaucoma tubes, and spinal disc repair. Example electrical leads may include, without limitation, implantable electrical stimulation or diagnostic systems including neurostimulation systems such as spinal cord stimulation (SCS) systems, deep brain stimulation (DBS) systems, peripheral nerve stimulation (PNS) systems, gastric nerve stimulation systems, cochlear implant systems, and retinal implant systems, among others, and cardiac systems including implantable cardiac rhythm management (CRM) systems, implantable cardioverter-defibrillators (ICD's), and cardiac resynchronization and defibrillation (CRDT) devices, among others.

### Prophetic Example 1

A polyisobutylene polyurethane material, such as an extruded or injected molded polyisobutylene polyurethane tube or film, will be submerged in a polar aprotic solvent, such as THF, an ether or acetone, with sodium carbonate or potassium carbonate or under basic conditions (i.e., pH 8-12) in a first container for about 30 minutes. A solution of Br-tailed PEG or other hydrophilic material will be prepared in a polar aprotic solvent in a second container. The contents of this second container will be combined with the polyisobutylene polyurethane in the first container. After about 30 minutes, the polyisobutylene polyurethane will be removed from the solution and washed with deionized (DI) water three times. The polyisobutylene polyurethane will then be dried. The dry polyisobutylene polyurethane will contain a hydrophilic coating on the surface through an Sn2 reaction.

### Prophetic Example 2

A polyisobutylene polyurethane material, such as an extruded or injected molded polyisobutylene polyurethane tube or film, will be submerged in a sodium acetate/ethyl acetate solution for about 30 minutes in a first container. A second solution will be formed in a second container by dissolving a Br-tailed hydrophilic polymer, such as Br-PEG, into ethyl acetate. The contents of the second container will be added to the polyisobutylene polyurethane in the first container. After about 30 minutes, the polyisobutylene polyurethane will be removed from the solution and washed with deionized (DI) water three times. The polyisobutylene polyurethane will then be dried. The dry polyisobutylene polyurethane will contain a hydrophilic coating on the surface through an Sn2 reaction.

### Prophetic Example 3

A polyisobutylene polyurethane material, such as an extruded or injected molded polyisobutylene polyurethane tube or film, will be submerged in sodium acetate (alternative, sodium carbonate or potassium carbonate can be used) aqueous solution for about 30 minutes in a first container. A second solution will be formed in a second container by dissolving a Br-tailed hydrophilic polymer, such as Br-PEG, into water. The contents of the second container will be added to the polyisobutylene polyurethane in the first container. After about 30 minutes, the polyisobutylene polyurethane will be removed from the solution and washed with deionized (DI) water three times. The polyisobutylene polyurethane will then be dried. The dry polyisobutylene polyurethane will contain a hydrophilic coating on the surface through an Sn2 reaction.

Various modifications and additions can be made to the embodiments discussed without departing from the scope of this disclosure. For example, while the embodiments described above refer to particular features, the scope of this disclosure also includes embodiments having different combinations of features and embodiments that do not include all of the described features. Accordingly, the scope of this disclosure is intended to embrace all such alternatives, modifications, and variations as fall within the scope of the claims, together with all equivalents thereof.

We claim:

1. A polymeric material comprising:
a polyisobutylene polyurethane including:
soft segments including a polyisobutylene diamine residue; and
hard segments including bis-cyclic carbonate residue.

2. The polymeric material of claim 1, wherein the polyisobutylene polyurethane is free of urea linkages.

3. The polymeric material of claim 1, wherein the hard segments further include ethanol side chains.

4. The polymeric material of claim 1, wherein the hard segments further include modifying moieties covalently bonded to a polymer backbone.

5. The polymeric material of claim 4, wherein the modifying moieties are from bromine-terminated polyethylene glycol (PEG-Br), quaternary ammonium bromine-terminated derivatives (small molecule or polymer-based), bromine-terminated polyvinylpyrrilidone (PVP-Br) or bromine-terminated poly (2-methyl-2-oxazoline).

6. The polymeric material of claim 4, wherein the modifying moieties from 8-bromo-1,1,1,2,2,3,3,4,4,5,5,6,6-tridecafluoro-octane, bromine-terminated polytetrafluoroethylene (PTFE-Br) or bromine-terminated polydimethylsiloxane (PDMS-Br).

7. A medical device comprising:
a polymeric material including:
a polyisobutylene polyurethane including:
soft segments including a polyisobutylene diamine residue; and
hard segments including bis-cyclic carbonate residue.

8. The medical device of claim 7, wherein the hard segments further include modifying moieties covalently bonded to a polymer backbone.

9. The medical device of claim 8, wherein the modifying moieties are only present at surfaces of the polyisobutylene polyurethane.

10. The medical device of claim 8, wherein the modifying moieties are present throughout the polyisobutylene polyurethane.

11. A method of making a polymeric material, the method comprising:
forming amino-terminated polyisobutylene from hydroxyl-terminated polyisobutylene; and
performing ring-opening polymerization with bis-cyclic carbonate and the amino-terminated polyisobutylene to form polyisobutylene polyurethane.

12. The method of claim 11, wherein forming the amino-terminated polyisobutylene includes adding methanesulfonyl chloride and ammonia to hydroxyl-terminated polyisobutylene.

13. The method of claim 11, wherein the bis-cyclic carbonate and the amino-terminated polyisobutylene are present in the ring-opening polymerization in equal molar amounts.

14. The method of claim 11, and further comprising performing a S_{N}² reaction with the polyisobutylene polyurethane to form a modified polyisobutylene polyurethane.

15. The method of claim 14 wherein the S_{N}² reaction includes bromine-terminated polyethylene glycol (PEG-Br), quaternary ammonium bromine-terminated derivatives (small molecule or polymer-based), bromine-terminated polyvinylpyrrilidone (PVP-Br) or bromine-terminated poly (2-methyl-2-oxazoline).

16. The method of claim 14, wherein the S_{N}² reaction includes 8-bromo-1,1,1,2,2,3,3,4,4,5,5,6,6-tridecafluoro-octane, bromine-terminated polytetrafluoroethylene (PTFE-Br) or bromine-terminated polydimethylsiloxane (PDMS-Br).

17. The method of claim 14, and further comprising forming the polyisobutylene polyurethane into a medical device.

18. The method of claim 17 wherein the S_{N}² reaction is performed before forming the medical device.

19. The method of claim 17 wherein the S_{N}² reaction is performed after forming the medical device.

20. The method of claim 19 wherein the S_{N}² reaction includes a polymer or molecule having a leaving group and a modifying moiety, wherein the leaving group is selected from the group consisting of bromide, iodide, chloride, tosylates and mesylates, and wherein the modifying moiety is selected from the group consisting of polyacrylates, acrylic acid copolymers, polyethylene glycol (PEG), polyvinylpyrrolidone (PVP), polyoxazolines, quaternary ammonium-functionalized polymers or molecules glycosaminoglycans and peptides.
